(19) United States
(12) Patent Application Publication
(10) Pub. No.: US 2025/0129238 A1
(43) Pub. Date: Apr. 24, 2025

(54) RUBBER COMPOSITION FOR DYNAMIC OR STATIC APPLICATIONS, PROCESS FOR PREPARING SAME AND PRODUCTS INCORPORATING SAME

(71) Applicant: HUTCHINSON, Paris (FR)

(72) Inventors: Etienne DELEBECQ, AMILLY (FR); Florian FANNECHERE, GRISELLES (FR)

(21) Appl. No.: 18/718,525

(22) PCT Filed: Dec. 13, 2022
(86) PCT No.: PCT/FR2022/052324

§ 371 Date: Aug. 5, 2024

(30) Foreign Application Priority Data
Dec. 17, 2021 (FR) FR2113837

(51) Int. Cl. C08L 7/00; C08J 3/24; C09K 3/10

(52) U.S. Cl. CPC C08L 7/00; C08J 3/247; C09K 3/10; C08J 2307/00; C08J 2423/12; C08L 2205/18; C08L 2312/00; C09K 2200/0607; C09K 2200/0617

(57) ABSTRACT

The invention relates to a crosslinkable rubber composition (I) based on an elastomer and to the process for preparing same. The composition (I) comprises a crosslinking system and a thermoplastic phase which is dispersed into particles, having a melting point MP or softening point SP, a glass transition temperature Tg and optionally a crystallisation temperature Tc, the system comprising sulfur when the elastomer is unsaturated and the phase comprises saturated chains, and a peroxide when the elastomer is saturated, the composition (I) comprising the product of: a) a melt reaction by thermomechanical working of the elastomer and other ingredients except for the system, comprising heating the mixture to a maximum temperature Ta that is greater than MP or SP, then b) mechanical working of the mixture obtained, with addition of the system. The particles comprise filaments or fibrils, the temperature of the mixture during b) being temporarily greater than Tc when the phase is crystalline, or than Tg when it is amorphous.

### TECHNICAL FIELD

The invention relates to a crosslinkable rubber composition, to the process for its preparation, to a crosslinked rubber composition, to a mechanical member with a dynamic function and to a sealing element, at least part of which comprises this crosslinked rubber composition. The invention applies notably to any industrial application using crosslinked rubber compositions, including said mechanical member with a dynamic function chosen in particular from anti-vibration supports and elastic joints for motor vehicles or industrial devices, and said sealing element chosen in particular from seals for vehicle bodywork and sealing profiles for buildings, without being limiting.

### PRIOR ART

Conventionally, the reinforcement of elastomers in rubber compositions is performed by adding fillers such as carbon black or silica, in order to improve the mechanical properties of the compositions by means of the hydrodynamic effect and of the interactions between the elastomer and the fillers, on the one hand, and between the fillers themselves, on the other hand. These fillers in powder form are dispersed in the rubber by thermomechanical working during mixing of the composition's ingredients, excluding the crosslinking system, by heating the mixture to a maximum temperature usually below 150° C., typically between 10° and 130° C. for a carbon black-filled ethylene-propylene-diene terpolymer (EPDM) type rubber.

However, these filler-elastomer and filler-filler interactions generate an adverse effect associated with hysteretic losses, commonly referred to as the Payne effect, which is reflected by non-linearity (i.e. amplitude stiffening) and stiffening notably at low temperatures of crosslinked rubber compositions subjected to dynamic stresses. This stiffening entails dynamic properties that may prove to be unsatisfactory for the compositions due to the abovementioned interactions with the reinforcing fillers used, these dynamic properties usually being able to be evaluated by measuring, at two dynamic strain amplitudes, a ratio of storage moduli G′ relative to the complex shear moduli G* of the compositions. As a reminder, the complex modulus G* is defined by the equation G*=G′+iG″, with:
G′: real part of G* called the storage or elastic modulus, G′ characterizing the stiffness or viscoelastic behavior of the composition (i.e. the energy conserved and totally restored); and
G″: imaginary part of G* called the loss or dissipation modulus, G″ characterizing the viscous behavior of the composition (i.e. the energy dissipated in the form of heat, it being specified that the ratio G″/G′ defines the loss factor tan delta).

This ratio typically corresponds to G′, measured at a low dynamic strain amplitude, relative to G′ measured at a high dynamic strain amplitude, the two moduli G′ being measured at the same frequency and at the same temperature (e.g. G′ 0.5%/G′ 20%). In a known manner, G′ 0.5%/G′ 20% is typically between 1.80 and 2.00 for a rubber composition based on a polyisoprene (IR) and reinforced with 40 phr of an N330 grade carbon black in order to be usable in dynamic applications (phr: parts by weight per 100 parts of elastomer). Indeed, it is known that in reinforced materials, the viscoelastic behavior varies starting from small dynamic strain amplitudes, with a substantial decrease in G′ with a significant increase in strain.

U.S. Pat. No. 8,247,494 B2 discloses, in order to overcome the abovementioned drawback of high hysteretic losses in conventionally filled compositions, a rubber composition which may be free of carbon black and silica and which is reinforced with a thermoplastic resin dispersed in the form of discrete domains in a continuous phase of a crosslinked olefinic rubber. Said document teaches how to crosslink rubber exclusively by hydrosilylation, to form silicon crosslinking bridges.

U.S. Pat. No. 3,965,055 A relates to a rubber composition, in which a semicrystalline thermoplastic resin (polypropylene in the examples) is dispersed in an elastomer as particles with a cross-sectional dimension D of at most 500 nm and an aspect ratio (length L/D) at least equal to 2, by mixing above the melting point of the resin and then stress-free crosslinking of the composition below said melting point. More precisely, the mixture obtained by a mixing step A is cooled during a step B below said melting point (for example to room temperature), and the cooled mixture is then placed during a step C on another mixer maintained at a sufficiently low temperature to avoid scorching of the mixture, and the crosslinking system is incorporated into the mixture at a temperature of 150 to 170° F. in the examples (65 to 93° C.), after which, in a step D, the composition obtained is fashioned below said melting point, and the article is then crosslinked in a step E. Mechanical working of the crosslinkable composition is thus performed cold during step C.

WO 2020/225498 A1 in the name of the Applicant discloses a crosslinkable rubber composition based on an elastomer, which comprises a crosslinking system and a thermoplastic phase which has at least one melting point Tf and which is dispersed in nodules (e.g. spherical or ellipsoidal), the crosslinking system comprising sulfur when the elastomer is unsaturated and said phase comprises saturated chains, and a peroxide when the elastomer is saturated. The composition comprises the product:
a) of a melt reaction by thermomechanical working of the elastomer and the other ingredients except the crosslinking system, with heating of the mixture to a temperature above Tf maintained for a holding time, to produce a precursor mixture for the composition, and then
b) of mechanical working of the precursor mixture with addition of the crosslinking system to produce the crosslinkable composition.

The examples in WO 2020/225498 A1 indicate that the mechanical working step b) (known as acceleration on rolls) is performed on day D of thermomechanical working step a), after prior cooling of the precursor mixture obtained in a) from 160° C. to a temperature of 30° C. The process according to WO 2020/225498 A1 makes it possible to obtain, by means of said nodules, improved scorch resistance for the crosslinkable composition and, for the crosslinked composition, reinforcement of the same order and improved mechanical properties even after thermo-oxidative or UV radiation-mediated aging, compared with a control composition based on the same ingredients except for the carbon black it contains instead of said thermoplastic phase.

In the course of its recent research, the Applicant sought to modify the mixing process according to these examples from WO 2020/225498 A1, notably in order to further improve the mechanical properties of the crosslinked rubber compositions obtained.

### DISCLOSURE OF THE INVENTION

One aim of the invention is to propose a rubber composition which not only remedies the abovementioned drawback of high hysteresis of carbon black- or silica-filled compositions, but also notably has further improved reinforcing properties relative to those of the compositions tested in WO 2020/225498 A1.

This aim is achieved in that the Applicant has just discovered in a surprising manner that if the abovementioned step b) of the precursor mixture according to WO 2020/225498 A1 is modified in such a way that the temperature Tb of the precursor mixture during mechanical working is temporarily higher than the crystallization temperature Tc or glass transition temperature Tg of the thermoplastic polymeric phase when said phase is partly crystalline or amorphous, respectively, then a mixture can be obtained which, after addition of the crosslinking system, gives a crosslinkable composition in which said phase is homogeneously dispersed in the elastomer matrix in the form of filaments or fibrils of specific morphology, which makes it possible, by means of this mechanical working temporarily performed above Tc or Tg, as the case may be, to obtain for the crosslinked composition increased hardness and improved reinforcement reflected by overall superior static and dynamic mechanical properties (including fatigue strength), compared with those of a control composition of the same formulation (i.e. based on the same ingredients and amounts) but obtained via the process exemplified in WO 2020/225498 A1.

More precisely, a crosslinkable composition according to the invention is based on at least one elastomer and comprises other ingredients which include a crosslinking system and a thermoplastic polymer phase which has at least a melting point Tf or softening point Tr, a glass transition temperature Tg and, when said phase is partly crystalline, a crystallization temperature Tc, said phase being dispersed in said at least one elastomer in the form of particles, the crosslinking system comprising sulfur when said at least one elastomer is unsaturated and said phase comprises saturated polymer chains, and comprising a peroxide when said at least one elastomer is saturated,
the crosslinkable composition comprising the product:
a) of a melt reaction by thermomechanical working of a reaction mixture comprising said at least one elastomer and said other ingredients with the exception of the crosslinking system to obtain a precursor mixture of the crosslinkable composition, the reaction comprising heating the reaction mixture to a maximum temperature Ta of said reaction mixture which is higher than said at least one temperature Tf or Tr, and then
b) mechanical working of the precursor mixture with addition of the crosslinking system, to produce the crosslinkable composition.

According to the invention, said particles comprise filaments or fibrils produced by these steps a) and b), the temperature Tb of the precursor mixture during the mechanical working of step b) being temporarily higher than said crystallization temperature Tc when the thermoplastic polymer phase is partly crystalline, or than said glass transition temperature Tg when the thermoplastic polymer phase is amorphous.

The term “based on” is used in the present description to mean that the composition or ingredient under consideration comprises a weight majority of the constituent concerned, i.e. in a mass fraction of greater than 50%, preferably greater than 75%, which may be up to 100%.

The terms “unsaturated” and “saturated” are understood in the manner described herein to mean a thermoplastic elastomer/polymer which includes at least one unsaturation (i.e. double or triple bond) and which is free of unsaturations (i.e. without double or triple bonds), respectively.

In the present description, the term “partly crystalline thermoplastic polymer phase” means that this phase comprises at least one semicrystalline thermoplastic polymer and thus has at least a melting point Tf, a softening point Tr and a crystallization temperature Tc, in addition to a glass transition temperature Tg (with Tg<Tc<Tr<Tf by definition).

In the present description, the term “amorphous thermoplastic polymer phase” means that this phase consists of at least one amorphous thermoplastic polymer having a softening point Tr, in addition to a glass transition temperature Tg (Tg<Tr).

The term “filaments or fibrils” is used in the present description to mean elongated fibers or fibrillated structures (e.g. nanofilaments) which differ from convex solids, such as spheres or ellipsoids, and may, for example, be of generally constant transverse width along the length (which may be straight, angled or curved) of the filament or fibril.

Preferably, the particles dispersed in a composition according to the invention comprise said filaments or fibrils in a volumetric fraction of greater than 70%, advantageously greater than 80%, or even greater than 90%.

It will be noted that a crosslinkable composition according to the invention thus unexpectedly allows, following thermomechanical working (with heating maintained for a given time), by said mechanical working at a temperature of the mixture Tb which is temporarily (i.e. for a given period of time) higher than the threshold Tc or Tg (threshold determined by the thermoplastic phase chosen), to obtain a dispersion of this phase in the elastomer matrix in the form of particles, which predominantly comprise or consist of these filaments or fibrils with a further optimized interface between the particles and this matrix, thus conferring on the composition these improved reinforcement properties under static and dynamic stresses.

Thus, as explained below, the crosslinkable composition according to the invention allows, following its thermal crosslinking via the crosslinking system incorporated in step b) which is suitable for the thermoplastic elastomer-phase couple, to confer on the crosslinked composition a Shore hardness and mechanical properties that are significantly improved relative to those of the similarly formulated control composition obtained according to the examples of WO 2020/225498 A1.

In general, any semicrystalline or amorphous thermoplastic polymer may be used as a thermoplastic phase, provided that it has sufficiently high stiffness at room temperature and is plastic or at least deformable during mixing. As explained below, the rigidity can be reduced by raising the temperature of the precursor mixture during the mechanical working step b) to above Tc for an at least partly crystalline phase, or to above Tg for an amorphous phase (e.g. consisting of at least one polystyrene as amorphous polymer, with a Tg in this example which may typically be between 80 and 105° C.).

It will also be noted that a composition according to the invention, characterized by dispersion of the thermoplastic phase in said at least one elastomer, is not to be confused with a thermoplastic vulcanizate in which the thermoplastic base contains a dispersion of rubber nodules.

Also generally speaking, the duration of heating maintenance in step a) may be at least 10 seconds, preferably being between 10 seconds and 10 minutes, more preferentially between 20 seconds and 5 minutes, for example between 30 seconds and 3 minutes.

According to another feature of the invention, the mechanical working of step b) may be initiated at an initial temperature Tb0 of the precursor mixture, with Tb0>Tc or Tb0>Tg when the thermoplastic polymer phase is partly crystalline or amorphous, respectively,
and preferably the mechanical working of step b) is initiated while said phase is in the molten or softened state in the precursor mixture.

It will be noted that the mechanical working according to the invention may thus be initiated at a temperature Tb0 that is sufficiently high for the thermoplastic phase to change from a non-crystalline or non-glassy state to a crystalline or glassy state, respectively, during step b), and preferably for this phase to be melted or at least softened in the precursor mixture, which may then be softened or even virtually liquid during the initiation of step b).

According to a preferential embodiment of the invention, the temperature Tb of the precursor mixture during step b) is at its highest when mechanical working is initiated, where Tb=Tb0, and then decreases until Tb<Tc or Tb<Tg, when the thermoplastic phase is partly crystalline or amorphous, respectively.

It will be noted that during this decrease in Tb with time from the initial instant to corresponding to Tb=Tb0, the thermoplastic phase passes from a non-crystalline or non-glassy state to a crystalline or glassy state, respectively, during the first few minutes of mechanical working (i.e. at the start of step b)).

Preferably, according to said preferential mode of the invention, mechanical working is initiated at said initial temperature Tb0 which is between
Tc or Tg, depending on whether the thermoplastic polymer phase is partly crystalline or amorphous, respectively, and
said maximum temperature Ta of the reaction mixture, which may coincide with the dropping temperature Tt (e.g. “steep dropping”) of the precursor mixture.

In other words, Tb0 is preferably between Tc and Ta or between Tg and Ta, and preferably Tb0 is between 11° and 220° C.

Even more preferentially, Tb0 is between 15° and 190° C. when the thermoplastic phase is partly crystalline (comprising e.g. a propylene homopolymer or copolymer) or amorphous (comprising e.g. a polystyrene), and the temperature Tb of the precursor mixture is highest at the initiation of mechanical working where Tb=Tb0, then decreases until Tb is between 1° and 90° C., for example.

In this case, the final value of Tb is then lower than Tc or Tg as explained above, this final value possibly varying to a large extent depending on the architecture chosen for the mixing and thermal regulation system.

In general, said crosslinking system is preferably incorporated into the precursor mixture after a homogenization time period for the latter, which time period (counted from the initiation of mechanical working) is, for example, between 1 min. and 5 minutes, for example between 2 min. and 4 min.

It will be noted that the initial temperature Tb0 of the precursor mixture at which step b) is initiated may be such that mechanical working begins when the precursor mixture is in a molten state (for example liquid or pasty) or at least softened, before the temperature Tb of the precursor mixture decreases as explained above.

According to another general feature of the invention, step a) may be followed by step b) in such a way that a time interval At separates the extraction of the precursor mixture at the end of step a) and the initiation of mechanical working in step b) after transferring the precursor mixture, providing a temperature difference ΔT=Tt−Tb0 between the dropping temperature Tt (e.g. “steep dropping”) of the precursor mixture at the end of step a) and the initial temperature Tb0 at the start of step b), such that ΔT/Tt<30% and preferably ΔT/Tt<20%.

Preferably, Δt<10 minutes (more preferentially Δt<2 minutes), for ΔT/Tt to be less than 10% and for example ΔT/Tt<1%, the precursor mixture then being cooled on conclusion of step a) essentially during said mechanical working, in such a manner that the precursor mixture is subjected to generally continuous shearing from the initiation of step a) until the end of step b).

It will be noted that the present invention may indeed be reflected by the fact that the cooling of the precursor mixture from the time it is extracted at the end of step a) is essentially performed by this shearing, i.e. virtually without cooling to room temperature pending mechanical working.

According to a general aspect of the invention, said particles dispersed in the composition (which particles consist of said filaments or fibrils in a volume fraction of at least 70%, preferably of at least 80%, more preferentially of at least 90%) may have at least one of the following morphological features:
(a) for their equivalent diameter, defined as the diameter of a hypothetical spherical particle of the same volume:
(i) an equivalent diameter ranging from 5 nm to 1000 nm and preferably from 10 nm to 330 nm for all the particles,
(ii) a median equivalent diameter of between 20 nm and 200 nm, preferably from 30 nm to 60 nm, and
(iii) a mean equivalent diameter of between 30 nm and 300 nm and preferably between 40 nm and 70 nm; and/or
(b) for their aspect ratio, defined by the ratio of the longest length to the smallest width of each particle:
(i) a mean aspect ratio greater than or equal to 2 and preferably between 2.0 and 2.5, and
(ii) a maximum aspect ratio for all the particles which is greater than 5, preferably between 10 and 15.

These particles may thus have the features [(a) (i) and/or (a) (ii) and/or (a) (iii)] and/or [(b) (i) and/or (b) (ii)], advantageously at least (a) (iii) and (b) (i). These features are measured by focused ion beam (FIB) scanning electron microscopy (SEM), which technique is known as FIB-SEM (focused ion beam-scanning electron microscopy).

The term “equivalent diameter” is thus used in the present description to mean a diameter of the equivalent sphere, corresponding to the diameter of a sphere which would have the same volume as the particle itself, but not the same projected area. This equivalent diameter thus corresponds to the diameter of a virtual spherical particle of radius R and of the same volume, i.e. this equivalent diameter is calculated from the volume V of the segmented object defined by V=4/3.π.R³.

The term “mean equivalent diameter” means herein the arithmetic number-mean equivalent diameter of the equivalent particle diameters, i.e. for a sample split into classes. The term “median equivalent diameter” means herein the median d₅₀ of the volume distribution, i.e. by definition the equivalent diameter corresponding to the cumulative frequency of 50%, which divides the histogram of relative frequencies into two parts of identical area.

The term “mean aspect ratio” means herein the arithmetic number-mean aspect ratio of the particles.

In general, the crosslinkable composition of the invention can comprise said thermoplastic phase in an amount of between 1 and 150 phr (phr: parts by weight per 100 parts of elastomer(s)) and preferably between 5 and 70 phr (even more preferentially between 10 and 30 phr).

According to another feature of the invention, the crosslinkable composition may comprise, as a powder filler dispersed in said at least one elastomer:
from 0 to 100 phr (preferably from 0 to 50 phr and even more preferentially from 0 to 10 phr, or even from 0 to 5 phr) of an organic filler such as carbon black, and
from 0 to 150 phr (for example from 10 to 100 phr) of a non-reinforcing inorganic filler other than silica (phr: parts by weight per 100 parts of elastomer(s)).

Advantageously, the crosslinkable composition may be totally free of organic or inorganic powder filler.

The term “filler” is used in the present description to mean one or more individual fillers of reinforcing or non-reinforcing grade(s) for the elastomer concerned which is/are homogeneously dispersed in powder form in the composition (in contrast to the nodules of the present invention), and the term “inorganic filler” is used to mean a clear filler (sometimes referred to as a “white filler”), as opposed to organic fillers such as carbon blacks and graphite, for example.

It will be noted that a composition according to the invention is thus free of carbon black or contains at most 100 phr thereof (preferably at most 50 phr, or even at most 10 phr or even at most 5 phr), and that this composition of the invention may be free of silica and may optionally comprise at most 70 phr of a non-reinforcing inorganic filler, such as chalk or an aluminosilicate such as kaolin, without being limiting.

According to a first embodiment of the invention, the crosslinking system comprises sulfur and optionally also a peroxide, said at least one elastomer being a rubber chosen from:
functionalized or non-functionalized olefinic rubbers, such as ethylene-alpha-olefin copolymers, for instance ethylene-propylene copolymers (EPM) and ethylene-propylene-diene terpolymers (EPDM), and
functionalized or non-functionalized diene rubbers derived at least partly from conjugated diene monomers, such as natural rubber (NR), isoprene homopolymers and copolymers and butadiene homopolymers and copolymers; and
said thermoplastic polymer phase comprises at least one saturated polymer preferably chosen from functionalized or non-functionalized aliphatic or aromatic polyolefins, for example ethylene or propylene homopolymers or copolymers.

It will be noted that this sulfur-based crosslinking system comprises in a known manner, in addition to sulfur, all or some of the usual vulcanization accelerators and activators.

As ethylene-alpha-olefin copolymers for olefinic rubbers, mention may be made generally of those derived from ethylene and an alpha-olefin containing from 3 to 20 carbon atoms and preferably from 3 to 12 carbon atoms, such as propylene, 1-butene, 1-pentene, 1-hexene, 4-methylpentene, 1-heptene, 1-octene, 1-nonene, 1-decene, 1-undecene and 1-dodecene. Alpha-olefins chosen from propylene, 1-butene, 1-hexene, 4-methyl-1-pentene and 1-octene are preferred.

As copolymers of isoprene and butadiene for diene rubbers, mention may be made, for example, of isoprene-butadiene copolymers (BIR), copolymers of isoprene and/or butadiene with a vinylaromatic comonomer such as styrene (SIR, SBR, SBIR).

According to one example of this first embodiment of the invention, said at least one elastomer is an EPDM with a mass content of units derived from ethylene of between 15% and 80%, and said thermoplastic polymer phase comprises at least one “aliphatic” polyolefin chosen from ethylene homopolymers, propylene homopolymers and polypropylene-ethylene-diene terpolymers with a mass content of units derived from ethylene of between 1% and 15%.

It will be noted that the EPDM that may be used as an elastomer in the composition of the invention may thus have a relatively high mass content of units derived from ethylene of between 60% and 80%, or conversely between 15% and 20%. As regards the aliphatic polyolefin forming the thermoplastic phase of the invention, it may be a “PEDM” predominantly derived from polypropylene, in a mass content of at least 80% (with, for example, between 5% and 15% ethylene and between 2.5% and 5% diene).

According to a second embodiment of the invention, the crosslinking system comprises a peroxide and optionally also sulfur, said at least one elastomer being saturated and said phase comprising saturated or unsaturated polymer chains, and preferably said at least one elastomer is a silicone rubber chosen, for example, from polydimethylsiloxanes (PDMS), and said phase comprises at least one saturated polymer chosen, for example, from phenyl silicone or alkyl silicone resins.

It will be noted that this peroxide-based crosslinking system may advantageously comprise an organic peroxide as crosslinking agent and a crosslinking coagent comprising triallyl cyanurate (TAC) or triallyl isocyanurate (TAIC), for example.

As silicone rubber, any polyorganosiloxane may be generally used, and as saturated polymer any thermoplastic silicone resin, for example of the alkyl (e.g. methyl) silicone or phenyl silicone type.

Another subject of the present invention is a crosslinked rubber composition, which is the product of thermal crosslinking of the crosslinkable composition as defined above by chemical reaction with said crosslinking system. This crosslinking may be obtained by setting the temperature between 14° and 220° C., preferably between 15° and 200° C.

It will be noted that a crosslinked composition according to the invention may have, like the crosslinkable composition, at least one of the abovementioned morphology features [(a) (i) and/or (a) (ii) and/or (a) (iii)] and/or [(b) (i) and/or (b) (ii)] for said particles dispersed in the composition.

According to another aspect of the invention, said crosslinked rubber composition may have at least one of the following properties (a), (b), (c) and (d):
(a) a Shore A hardness measured according to the standard ASTM D 2240 which is greater than or equal to 60, preferably between 65 and 70;
(b) secant moduli M100, M200 and M300 at 100%, 200% and 300% strain, measured in uniaxial tension according to the standard ASTM D 412, which are respectively greater than 3 MPa, 6 MPa and 9 MPa, and preferably respectively greater than 6 MPa, 9 MPa and 12 MPa;
(c) a modulus ratio M 155 Hz/M 15 Hz and a loss factor tan D at 15 Hz which are measured at 23° C. via a frequency sweep according to the standard ISO 4664 by a Metravib® visco-analyzer on Metravib® block-type specimens and which satisfy at least one of the following conditions (i) and (ii):
(i) M 155 Hz/M 15 Hz≤1.50,
(ii) a dynamic modulus at 15 Hz≥7 MPa, and
(iii) tan D at 15 Hz≤0.10; and
(d) a fatigue strength greater than 5×10⁶ cycles, measured at a frequency of 5 Hz and a temperature of 23° C. with a hydraulic endurance machine “MTS 831.02 Elastomer Test System” with a maximum capacity of 25 KN, equipped with a 15 kN force cell and a ±60 mm stroke cylinder, controlled by “MTS Flextest 40” software on “mini-diabolos” specimens with a minimum force of 0 N and a maximum force of 250 N, 200 N, 125 N and 100 N.

Preferably, these properties (a), (b), (c) and/or (d) are obtained in accordance with said first mode of the invention, i.e. with the crosslinking system which is sulfur-based, said at least one elastomer which is an olefinic rubber (e.g. EPM or EPDM) or a diene rubber derived from conjugated dienes (e.g. NR), and said thermoplastic phase which comprises a saturated polymer (e.g. aliphatic or aromatic polyolefin, for instance an ethylene or propylene homopolymer or copolymer, or a polystyrene).

It will be noted that the hardness and mechanical properties of the crosslinked composition according to the invention are advantageously superior to those of a control composition based on the same ingredients, but obtained via the process exemplified in WO 2020/225498 A1 (and accordingly incorporating nodules, instead of the dispersed filaments or fibrils according to the invention). Specifically, the Applicant has verified that a crosslinked composition according to the invention has very markedly increased static moduli compared with those of the control composition obtained according to the examples in WO 2020/225498 A1, and also improved dynamic properties compared with those of said control composition, including a much higher fatigue strength than the latter.

As indicated above for the crosslinkable composition, the crosslinked composition of the invention may be free of any powder filler (organic or inorganic).

According to said second embodiment of the invention where said at least one elastomer comprises said silicone rubber preferably chosen from PDMS and said thermoplastic phase comprises said at least one saturated polymer preferably chosen from phenyl or alkyl silicone resins, the crosslinked composition can thus be totally free of silica.

Surprisingly, it will be noted that this absence of silica in such a silicone rubber-based rubber composition (which usually contains silica as a reinforcing filler) means that the high level of reinforcement obtained by means of the dispersion of phenyl or alkyl silicone resin filaments or fibrils is not reflected in mechanical non-linearities observed under dynamic stress, which is advantageously reflected in a similarly reduced Payne effect for this second mode compared to a control composition based on the same ingredients (e.g. the same elastomer matrix and crosslinking system) but filled with carbon black instead of this resin.

It will also be noted that the mechanical properties described above for the crosslinked compositions of the invention are scarcely penalized following thermo-oxidizing aging (i.e. under hot air), or following aging by exposure to UV radiation.

A mechanical member with a dynamic function according to the invention is in particular chosen from anti-vibration mounts and elastic joints for motor vehicles or industrial devices, said member comprising at least one elastic part which consists of a crosslinked rubber composition and which is suitable for being subjected to dynamic stresses, and according to the invention said crosslinked composition is as defined above.

A sealing element according to the invention is in particular chosen from vehicle bodywork seals and building sealing profiles, said sealing element comprising an elastic part which consists of a crosslinked rubber composition, and according to the invention the crosslinked rubber composition is as defined above.

It will be noted that in this case, for example in a gasket sealing a motor vehicle bodywork, it is possible to incorporate into the composition of the invention not more than 100 phr of carbon black and between 10 and 60 phr of an inorganic filler other than silica, for example chalk or an aluminosilicate such as kaolin, combined with a metal oxide such as calcium oxide.

A process for preparing a crosslinkable composition according to the invention as defined above comprises the following steps:
a) in an internal mixer, for example tangential or meshing (i.e. with geared rotors), or in a screw extruder, for example twin-screw:
a0) introduction of said at least one elastomer and then of said other ingredients with the exception of said crosslinking system;
a1) thermomechanical working comprising melt mixing of said reaction mixture, with the exception of the crosslinking system, to produce a precursor mixture for the crosslinkable composition;
a2) heating the reaction mixture to said maximum temperature Ta of the reaction mixture, which is higher than said at least one melting point Tf or softening point Tr of the thermoplastic polymer phase, preferably by a difference Ta-Tf or Ta-Tr of between 1 and 100° C.;
a3) stabilizing said heating for a holding time period of at least 10 seconds, preferably between 20 seconds and 5 min;
a4) extraction of the precursor mixture from the internal mixer or screw extruder; and then
b) mechanical working of the precursor mixture in an external roll mixer or in a conical twin-screw device, with addition of said crosslinking system comprising sulfur and/or a peroxide to produce the crosslinkable rubber composition, in such a manner that the temperature Tb of the precursor mixture is temporarily greater than:
   said crystallization temperature Tc when the thermoplastic polymer phase is partly crystalline, and
   said glass transition temperature Tg when the thermoplastic polymer phase is amorphous.

Preferably, step b) is initiated at a maximum initial temperature Tb0 of the precursor mixture, with Tb0>Tc or Tb0>Tg when the thermoplastic phase is partly crystalline or amorphous, respectively.

More preferentially, step b) is initiated while the thermoplastic phase is in the softened and, for example, molten state in the precursor mixture, with the temperature Tb decreasing until Tb<Tc or Tb<Tg.

Even more preferentially, step a4) is followed by step b) in such a manner that a time interval Δt separates the extraction of the precursor mixture from the internal mixer or screw extruder and the initiation of the mechanical working in step b) (after transfer of the precursor mixture into said external roll mixer or conical twin-screw device), providing a temperature difference ΔT=Tt−Tb0 between the dropping temperature Tt (e.g. “steep dropping”) of the precursor mixture at the end of step a4) and the initial temperature Tb0 at the start of step b), such that ΔT/Tt<30% and preferably ΔT/Tt<20%.

Advantageously, Δt<10 minutes and for example Δt<2 minutes, so that ΔT/Tt<10% and for example ΔT/Tt<1%.

As explained above, it will be noted that in this manner the precursor mixture is cooled on conclusion of step a4) essentially by the mechanical working of step b), by being subjected to generally continuous shearing from step a1) until the end of step b).

With regard to step a2) of the process of the invention, the difference Ta−Tf or Ta−Tr, as the case may be, may advantageously be between 5 and 100° C., preferably between 1° and 70° C.

It will be noted that the value chosen for Ta thus depends on that of Tf or Tr which characterizes the thermoplastic polymer phase used, and that in the case where the latter is based on an aliphatic polyolefin such as a propylene homopolymer or copolymer, Ta may, for example, be between 16° and 220° C., preferably between 17° and 200° C., whereas in the case where this thermoplastic phase is an alkyl or phenyl silicone resin, Ta may be, for example, between 7° and 150° C., preferably between 8° and 120° C.

Advantageously, the heating of step a2) may be performed by using:
in said internal mixer:
a shear rate of said reaction mixture in the internal mixer of at least 80 s⁻¹, preferably at least 150 s⁻¹, for example operated at a rotor blade speed in the internal mixer of between 10 and 200 rpm, and preferably between 50 and 120 rpm, and/or
a jacket in the internal mixer receiving a heat-transfer fluid, and/or
using a degree of filling of the internal mixer of greater than 100%; or
in said screw extruder, heating elements fitted to the extruder.

It will be noted that such a shear rate (for example between 100 and 300 s⁻¹) can be used in a tangential (e.g. Banbury type) or meshing (Haake type) internal mixer.

It will also be noted that a rotational speed of 200 rpm is in particular suitable for a Haake mixer, whereas a rotational speed of about 100 rpm is more suitable for a Shaw 3.6L mixer.

With regard to step b) of mechanical working according to the invention, it should be noted that it may be performed other than in an external roll mixer or in a conical twin-screw device, provided that the precursor mixture resulting from step a4) is cooled immediately by the mechanical working of step b) alone, by thus being subjected to generally continuous shearing between step a4) and the end of step b), passing from a molten, softened or at least non-crystalline initial state to a crystalline state (in the case of a partly crystalline thermoplastic phase), or from a softened or at least non-glassy initial state to a glassy state (in the case of an amorphous thermoplastic phase).

### BRIEF DESCRIPTION OF THE DRAWINGS

Other features, advantages and details of the present invention will emerge on reading the following description of several examples of implementation of the invention, which are given as nonlimiting illustrations in relation with the attached drawings, among which:

FIG. 1 is a relative enthalpy-temperature graph showing the thermal behavior of “PPH 3060” polypropylene forming the thermoplastic polymer phase in crosslinkable composition I according to the invention and control crosslinkable composition C3.

FIG. 2 is an infrared camera image of the precursor mixture of crosslinkable composition I according to the invention, at the outlet of the internal mixer used in step a).

FIG. 3 is an infrared camera image of crosslinkable composition I according to the invention, at the outlet of the external mixer used in step b).

FIG. 4 is a graph showing the evolution as a function of time, during the mechanical working step b), of the temperatures of the respective precursor mixtures of crosslinkable composition I and crosslinkable composition C3, these temperatures being measured from the initial instant t0=0 min. 0 s corresponding to the initial temperature Tb0 of each precursor mixture at the initiation of step b).

FIG. 5 is a first image illustrating the three-dimensional morphology (axes in nm) of the dispersion in the form of nodules of the polypropylene forming the thermoplastic polymer phase of the control crosslinked composition C3, obtained by segmentation via the FIB-SEM focused ion beam (FIB) scanning electron microscopy (SEM) technique.

FIG. 6 is a second image illustrating the two-dimensional morphology (in nm) of the dispersion in the form of nodules of polypropylene in the control crosslinked composition C3, obtained by segmentation via the same FIB-SEM technique.

FIG. 7 is a first image illustrating the three-dimensional morphology (in nm) of the dispersion in the form of polypropylene filaments or fibrils forming the thermoplastic phase of crosslinked composition I according to the invention, obtained by segmentation via the same FIB-SEM technique as for FIG. 5.

FIG. 8 is a second image illustrating the two-dimensional morphology (in nm) of the dispersion in the form of polypropylene filaments or fibrils in crosslinked composition I according to the invention, obtained by segmentation via the same FIB-SEM technique as for FIG. 6.

FIG. 9 is a diagram illustrating, after analysis by FIB-SEM, the volumetric distribution of the equivalent diameters of the filaments or fibrils of crosslinked composition I according to the invention, and that of the nodules of the control crosslinked composition C3, the equivalent diameters being weighted by their volume fractions in the total dispersed polypropylene.

FIG. 10 is a diagram illustrating, after analysis by FIB-SEM, the numerical distribution of the aspect ratios of the filaments or fibrils of the crosslinked composition I according to the invention, and that of the aspect ratios of the nodules of the control crosslinked composition C3.

FIG. 11 is a diagram illustrating, after analysis by FIB-SEM, the correlations measured for the crosslinked composition I according to the invention and the control crosslinked composition C3, between the particle aspect ratios (i.e. filaments or fibrils for I and nodules for C3) and their equivalent diameters.

FIG. 12 is a graph collating the stress-strain characteristic curves for crosslinked composition I according to the invention and for the control crosslinked compositions C1, C2 and C3.

FIG. 13 is a graph of fatigue strength versus applied force, collating the curves for the number of cycles without rupture as a function of the intensity of the applied forces, for the crosslinked composition I according to the invention and the control crosslinked composition C2.

### EXAMPLES OF IMPLEMENTATION OF THE INVENTION

In the examples presented below, the following were prepared:
control crosslinkable compositions C1, C2 and C3 based on the same natural rubber (NR), C1 not being reinforced, C2 being reinforced solely with carbon black and C3 being reinforced solely with polypropylene (abbreviated as PP below) nodules, and
a crosslinkable composition I according to the invention based on the same natural rubber and the same other ingredients as composition C3, but composition I being reinforced with nanofilaments or nanofibrils of the same PP in place of said nodules, and having been obtained via a mixing process different from that used for composition C3, as explained below.

Table 1 details the formulations in phr (parts by weight per 100 parts of NR elastomer) of the masterbatches (consisting of the precursor mixtures obtained by step a) of thermomechanical working, before step b) of mechanical working and the addition of the crosslinking systems), and of the crosslinkable compositions C1-C3 and I which were derived from these masterbatches.

TABLE 1

| Ingredients/compositions | C1 | C2 | C3 | I |
|---|---|---|---|---|
| NR | 100 | 100 | 100 | 100 |
| ZnO | 5 | 5 | 5 | 5 |
| Stearic acid | 2 | 2 | 2 | 2 |
| N330 black | 0 | 41 | | |
| PPH 3060 | 0 | 0 | 13 | 13 |
| Protectors | 3.5 | 2.0 | 2.0 | 2.0 |
| Plasticizers and processing aids | 5.0 | 5.3 | 5.0 | 5.0 |
| TOTAL in phr of the masterbatch | 115.5 | 155.3 | 127.0 | 127.0 |
| Sulfur-based crosslinking system | 3.5 | 3.5 | 3.5 | 3.5 |
| TOTAL (phr) | 119.0 | 158.8 | 130.5 | 130.5 |

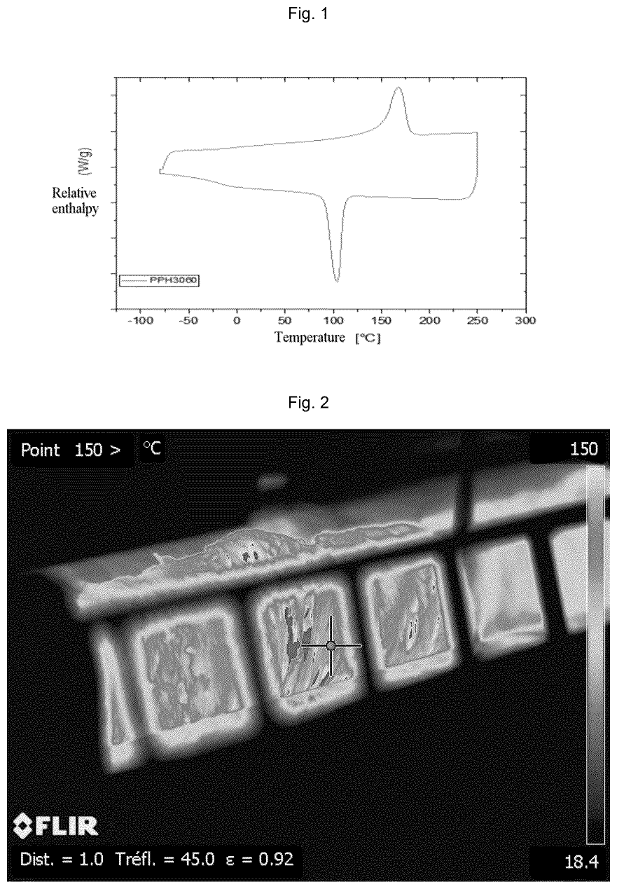

The enthalpy diagram of the PP “PPH 3060” used in compositions C3 and I to produce particles dispersed in the NR matrix, as shown in FIG. 1, shows, on the one hand, the melting point Tf of the PP (upper endothermic transition peak) at about 165° C. and, on the other hand, the crystallization temperature Tc of the PP (lower exothermic transition peak) at 100-110° C.

In the present description, the thermal behavior of the thermoplastic polymer phase, e.g. consisting of “PPH 3060” (density 0.905, measured according to the standard ISO 1183), including the measured temperatures Tf, Tr, Tc and Tg, was obtained by differential scanning calorimetry (“DSC” according to the standard ISO 11357), as explained below.
Programming: double sweep from −80° C. to 250° C. at 20° C./min. under N₂ at 50 mL/min. with a 5 min. isotherm at each steady stage.
Reproducibility: two tests/sample.
Apparatus: DSC with thermal flow—DSC1—“Mettler-Toledo”.
Calibration: Mettler-Toledo specific procedure, with standards: N-octane/indium/zinc.

The abovementioned crosslinkable compositions C1-C3 and I were prepared by performing:
step a) thermomechanical working on a 3160 cm³ “Shaw” internal mixer with geared rotors, using a filling coefficient of 1.00 for composition C2 and 1.10 for compositions C3 and I, and
step b) mechanical working (commonly known as the “acceleration step) on a “Comerio” open roll mixer.

More precisely, the following successive steps were performed to prepare each of the compositions C1-C2, composition C3 and composition I, as detailed in the three processes detailed below.

### Preparation of Each of the Two Polypropylene-Free Compositions C1-C2:

Filling of the internal mixer:
t=0 min.
material: NR
speed: 50 rpm.
T_{regulation}=80° C.

Plasticizing:
tₜₒₜₐₗ=1 min.
material: −
speed: 50 rpm.
T_{regulation}=80° C.

Filling:
tₜₒₜₐₗ=1 min.
material: filler (for composition C2)+additives (for compositions C1-C2)
speed: 50 rpm.
T_{regulation}=80° C.

Mixing:
t+1 min.
material: −
speed: 50 rpm.

Mixing with self-heating:
tₜₒₜₐₗ=[3 min.; 3 min. 30 s]
material: −
speed: 96 rpm.
T_{self-heating}=150° C.

Dropping of the mixture.

Cooling on open roll mixer:
t=0
Duration=1 min.
T_{regulation}=20° C.

Acceleration on the open mixer rolls:
Crosslinking system added after t=3 min.
   Preparation of Composition C3 with Polypropylene Nodules:

Filling of the internal mixer:
t=0 min.
material: NR
speed: 50 rpm and T_{regulation}=80° C.

Plasticizing:
tₜₒₜₐₗ=1 min.
material: −
speed: 50 rpm and T_{regulation}=80° C.

### Filling:

tₜₒₜₐₗ=1 min.
material: PP+additives
speed: 50 rpm and T_{regulation}=80° C.

Mixing with self-heating:
tₜₒₜₐₗ=[3 min.; 3 min. 30 s]
material: −
speed: 96 rpm and T_{self-heating}=140° C.

Self-heating maintained:
temperature held for 30 sec.
speed: 96 rpm.

Dropping of the mixture.

Cooling:
for about 24 h and T_{regulation}=20° C.

Transferring the cooled mixture to the open mixer and accelerating: Addition of crosslinking system after t=3 min on the rolls.

Preparation of Composition I with Polypropylene Filaments or Fibrils:

Filling of the internal mixer:
t=0 min.
material: NR
speed: 50 rpm and T_{regulation}=80° C.

Plasticizing:
tₜₒₜₐₗ=1 min.
material: −
speed: 50 rpm and T_{regulation}=80° C.

Filling:
tₜₒₜₐₗ=1 min.
material: PP+additives
speed: 50 rpm and T_{regulation}=80° C.

Mixing with self-heating:
tₜₒₜₐₗ=[3 min.; 3 min. 30 s]
material: −
speed: 96 rpm and T_{self-heating}=140° C.

Self-heating maintained:
temperature held for 30 sec.
speed: 96 rpm.

Dropping of the mixture.

Immediate cooling in the open roll mixer:
t=0: mixture extracted from internal mixer
Introduction onto the rolls: 1 min. after extraction, with T_{regulation}=20° C.

Acceleration on the rolls of the open mixer:
Crosslinking system added after t=3 min.

### Steps a) and b) Performed for Crosslinkable Compositions C3 and I:

Table 2 below compares the implementation of steps a) of thermomechanical mixing and b) of mechanical working, as a function of the regulation temperatures used and of the temperatures precisely measured at the core of the precursor mixture, for crosslinkable compositions C3 and I.

TABLE 2

| | | Composition C3 | | | | Composition I | | | |
|---|---|---|---|---|---|---|---|---|---|
| Steps | Temperatures and durations | Theory | | Measured | | Theory | | Measured | |
| Internal | Room temperature | / | | 21.5° | C. | / | | 20.4° | C. |
| mixer (IM) | Melt starting temperature | 140° | C. | 147° | C. | 140° | C. | 145° | C. |
| | measured by probe in IM | | | | | | | | |
| | Duration of holding at 140° C. | 0 | | 0.5 | min | 0.5 | min | 0.5 | min |
| | Dropping temperature | / | | 149° | C. | / | | 148° | C. |
| | measured by probe in IM | | | | | | | | |
| | Sharp dropping temperature | / | | 168.9° | C. | / | | 171° | C. |
| Open roll | Regulation temperature on | 20° | C. | 20° | C. | 20° | C. | 20° | C. |
| mixer | the rolls | | | | | | | | |
| | Duration between extraction | <24 | h | 20 | h | Almost | | 1 | min. |
| | from the IM and deposition | | | | | zero | | | |
| | on the rolls | | | | | | | | |
| | Temperature of the mixture | <110° | C. | 23° | C. | >110° | C. | 170° | C. |
| | during deposition on the rolls | | | | | | | | |
| | Homogenization time before | / | | 3 min 20 s | | / | | 3 min 10 s | |
| | crosslinking system | | | | | | | | |
| | Temperature of the mixture | <90° | C. | 67° | C. | <90° | C. | 70° | C. |
| | during working | | | | | | | | |
| | Temperature of the mixture | / | | 70° | C. | / | | 70° | C. |
| | exiting the rolls | | | | | | | | |

More specifically, it should be noted that all the temperatures measured during steps a) and b) (i.e. indicated by “measured” in the second column for composition C3 and composition I) were precisely measured in each precursor mixture of composition C3 and I.

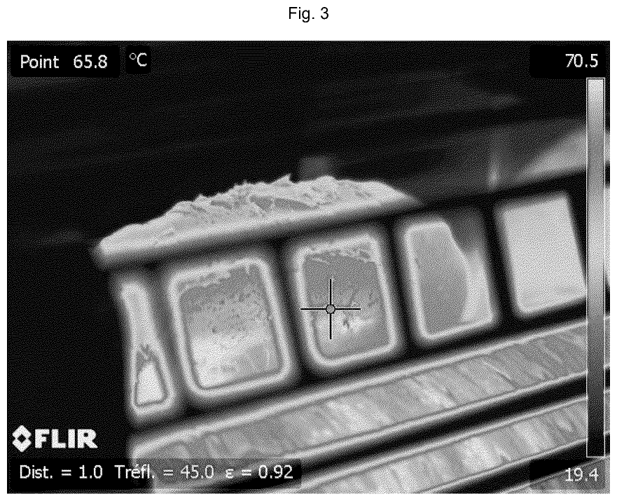

The image in FIG. 2 shows the appearance of the precursor mixture of crosslinkable composition I according to the invention at the outlet of the internal mixer, and the image in FIG. 3 shows the appearance of this composition | after acceleration on the rolls of the open mixer (i.e. at the end of mechanical working), these images having been obtained by an “FLIR SC660” high-definition infrared camera.

Thus, composition I according to the invention was extracted from the internal mixer at a temperature of 171° C., which was the “steep dropping” temperature taken at the core of the precursor mixture using a “Testo 925” pyrometer. The composition I precursor mixture was then immediately deposited on the open roll mixer.

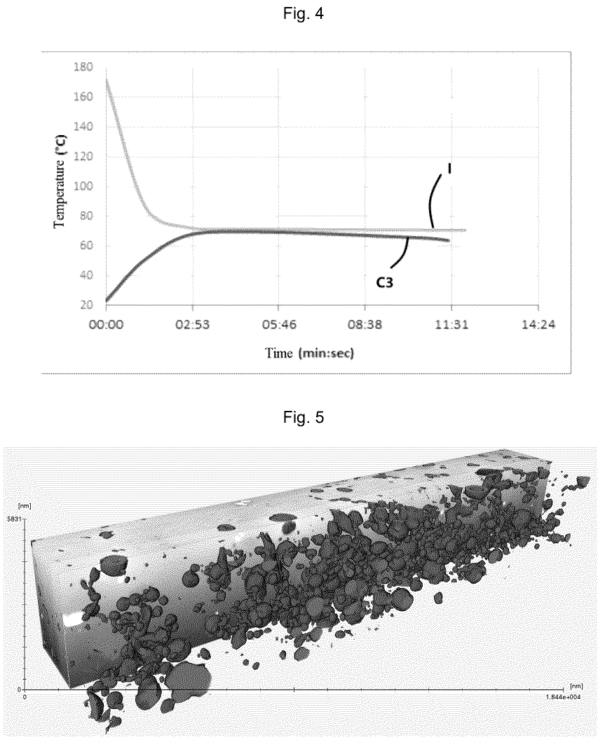

As shown in the graph in FIG. 4, the initial temperature Tb0 of 170° C. at the core of the precursor mixture at t0=0 (initial instant of mechanical working) decreased during about the first 3 minutes of mixing, until it stabilized at about 70° C. (see the almost linear decrease in temperature Tb of the precursor mixture of composition I in this example, and then the clear slowdown of this decrease shortly before 3 min. of working). The crosslinking system was added about 3 min after to.

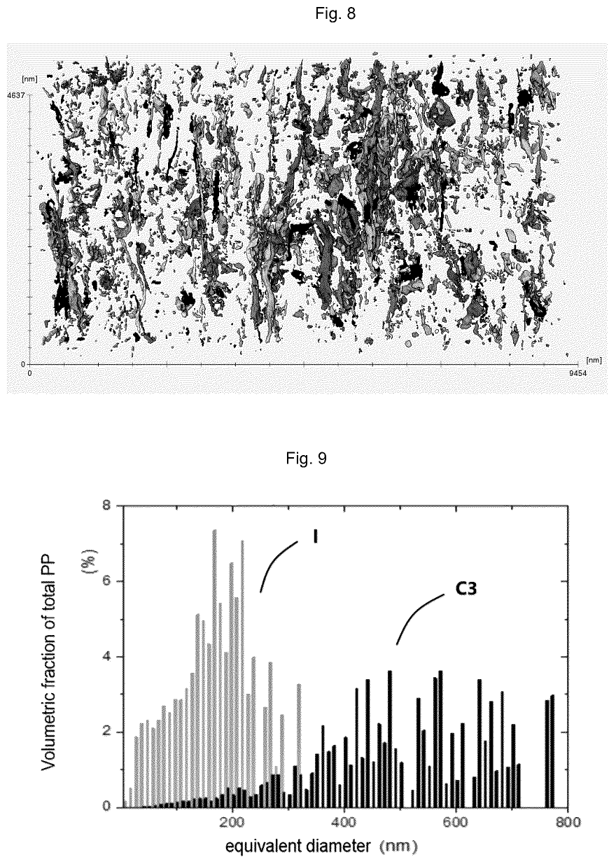

Thus, the PP contained in the precursor mixture of composition I was first worked in the liquid state and then during its crystallization (at about 100-110° C.) which took place under shear, i.e. in accordance with the invention as generally defined in the present description. As a result, the abovementioned nanofilaments or nanofibrils were obtained, homogeneously dispersed in crosslinkable composition I, as illustrated in FIGS. 7 and 8.

It will be noted that the cooling kinetics via the process of the invention, which in the example shown in FIG. 4 for composition I is defined over time by a continuously decreasing and then substantially constant temperature reflected by a globally convex curve (i.e. with upward-facing concavity), nevertheless depends on the amount of precursor mixture and the equipment used for the mechanical working (roll dimensions, thermoregulator power, etc.).

In contrast to this process, after step a) of thermomechanical working in the internal mixer, the precursor mixture of crosslinkable composition C3 was left to cool for 20 h without any shearing (i.e. cooling at rest for almost a day in ambient air). During this time, the temperature of the precursor mixture of composition C3 decreased from 168.9° C. (“steep dropping” temperature, i.e. the temperature of extraction of the precursor mixture from the internal mixer) to 23° C. (temperature Tb0 of initiation of mechanical working at t0=0), the PP having crystallized at about 100-110° C. at rest (i.e. in the absence of any shear), contrary to the general principle of the invention defined above.

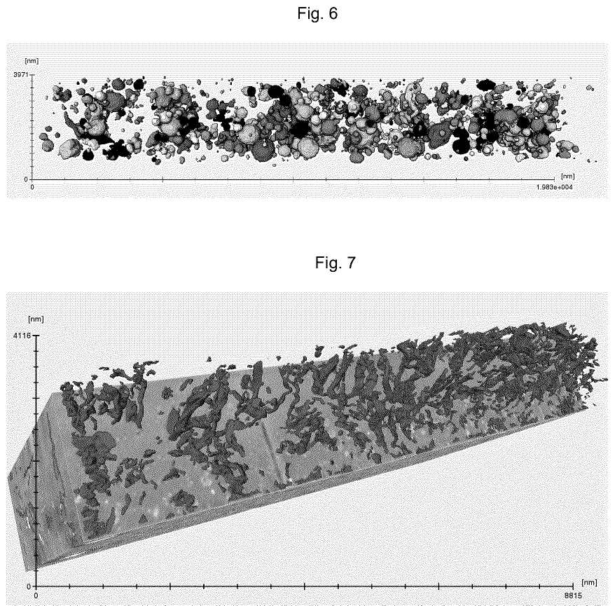

Mechanical working was thus started on the open roll mixer at room temperature (Tb0=23° C.), and then self-heating of the C3 precursor mixture to about 70° C. was generated by adding the crosslinking system about 3 min. after to, but without passing above the PP melting point (Tf of 165° C.). As illustrated in FIGS. 5-6, the generally spherical or ellipsoidal nodule morphology for composition C3, acquired during the thermomechanical working in step a), was thus preserved.

It can be seen in FIG. 4 that the cooling kinetics via the process not in accordance with the invention used for control composition C3, which is defined over time by a continuously increasing and then substantially constant temperature, is reflected by a globally concave curve (i.e. with the concavity facing downward), very different from and even virtually opposed to that characterizing composition I of the invention (on either side of the horizontal line defined by the final temperature of 70° C.).

### Vulcanization of Control Compositions C1-C3 and Composition I According to the Invention:

Table 3 below details the vulcanization conditions followed (temperature of 155° C. for 20 min.) for compositions C1-C3 and I.

TABLE 3

| Rheological properties | | | | |
|---|---|---|---|---|
| at 155° C. for 20 min. | C1 | C2 | C3 | I |
| Cₘᵢₙ (dN · m) | 0.6 | 1.47 | 0.26 | 0.64 |
| Cₘₐₓ (dN · m) | 6.8 | 16.37 | 9.01 | 9.53 |
| Delta C (dN · m) | 6.3 | 14.90 | 8.75 | 8.89 |
| t 05 (min.) | 7.1 | 5.27 | 9.85 | 9.52 |
| t 90 (min.) | 13.8 | 9.88 | 15.99 | 16.03 |
| t 95 (min.) | 15.5 | 11.23 | 17.51 | 17.47 |

### Morphological Characterization of Crosslinked Compositions C3 and I:

The morphology of compositions C3 and I was analyzed by segmentation via the FIB-SEM technique of focused ion beam (FIB) scanning electron microscopy (SEM), as explained below.

### Preparation of the Samples:

Each sample was first surfaced by cryo-ultramicrotomy, to obtain a flat surface. The surface obtained was placed in contact with a solution of osmium tetroxide (4% in water) for 3 days. After contrast, a second surfacing of the cryo-ultramicrotomy-treated area was performed, to remove the surface layer impaired by direct contact with the osmium.

### Implementation of the FIB-SEM Technique:

FIB-SEM ACQUISITION (XB540 Zeiss, “Atlas V software”). SEM: 1.5 kV, 149 pA—exposure time per voxel: 0.3 μs.
average per line: 18.
voxel size: 10 nm.
Detector: EsB.
FIB: 30 kV, 300 pA-Grinding speed: 6.6 nm/min.
3D tracking: exposure time per voxel: 0.6 μs.
Average per line: 20.
Volume: 20×5×4 μm.
PRE-TREATMENT:
Average non-local denoising-patch 7, search 21, similarity 0.5.
Normalizing, C and B corrections.
Z resampling to 10 nm (cubic).
Equalization, median filter.
SEGMENTATION:
Machine learning (“Ilastik”).
Resampling to 20 nm.
Aperture 1 for PP phase.

Global and individual analysis with “AVIZO”.

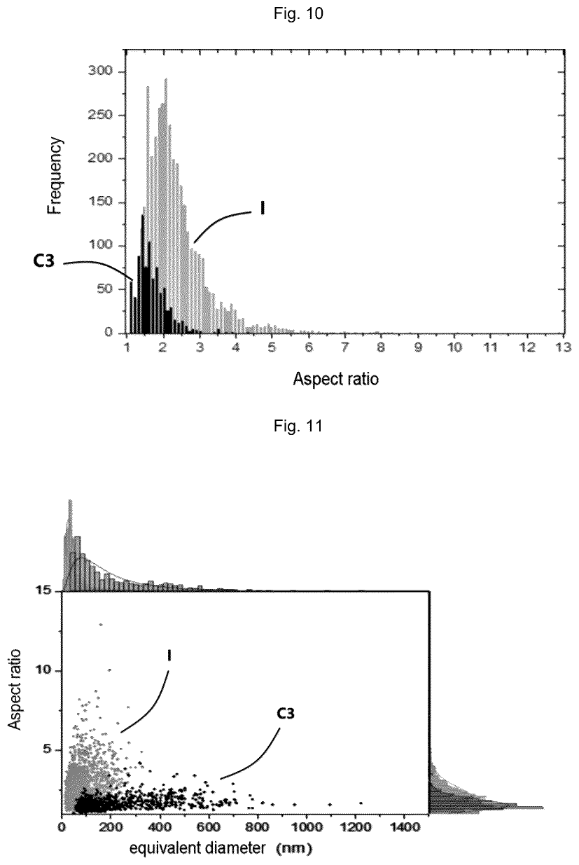

In conjunction with the diagrams in FIGS. 9-11, the images in FIGS. 5-6 illustrate the morphology of the globally spherical or ellipsoidal nodules dispersed in the crosslinked composition C3 (a morphology which also characterizes composition C3 in the crosslinkable state obtained following mechanical working step b), prior to crosslinking). As explained above:
each measured equivalent diameter refers to the diameter of a hypothetical spherical particle of the same volume as the observed particle (the “mean equivalent diameter” denotes the arithmetic number-mean equivalent diameter of the equivalent diameters of the particles for the sample split into classes, and the “median equivalent diameter” denotes the median d₅₀ of the volume distribution);
the aspect ratio denotes the ratio of the greatest length to the smallest width of each observed particle, the width possibly being assimilated to a minimum diameter in the case of an ellipsoidal nodule or a globally cylindrical filament (the term “mean aspect ratio” means the arithmetic number-mean aspect ratio of the particles); and
the term “volumetric fraction of total PP” (y axis in FIG. 9) means the ratio of the total volume of class X particles to the total volume of PP (ratio multiplied by 100 to obtain this fraction in %).

Table 4 below details the individual analyses performed to quantify the morphological parameters of the PP nodules in crosslinked composition C3, and of dispersed filaments or fibrils in crosslinked composition I.

TABLE 4

| Analysis of PP dispersion | Composition C3 | Composition I |
|---|---|---|
| Mean equivalent diameter | 211 nm | 50 nm |
| Median equivalent diameter | 140 nm | 37 nm |
| Mean aspect ratio | 1.6 | 2.1 |
| Maximum aspect ratio | 4 | 13 |

These parameters attest to the significant difference between the nanofilaments or fibrils of reduced equivalent diameters characterizing the dispersion of PP in composition I of the invention, and the spherical or ellipsoidal nodules characterizing the dispersion of PP in control composition C3.

### Standards and Protocols Followed for Tests on Compositions C1-C3 and I:

### Standardized Measurements:

Moving Die Rheometer (“MDR”): according to the standard ISO 6502:2016.

Shore A hardness: according to the standard ASTM D 2240.

Tensile tests: according to the standard ASTM D 412.

### Dynamic Mechanical Analysis (DMA) Tests:

For these “DMA” tests, ISO standard 4664 was followed, using the Metravib® visco-analyzer:
Conditions: −10%±0.1% at 155 Hz and −10%±2% at 15 Hz;
Specimens: Metravib® type blocks;
Number of specimens: three per condition;
Measuring temperature: 23° C.;
Lubricant: silicone oil spray.

### Fatigue Strength:

An “MTS 831.02” hydraulic endurance machine, with a maximum capacity of 25 KN, equipped with a 15 kN force cell and a cylinder with a stroke of ±60 mm, was used as the elastomer test system. The test was run with the “MTS Flextest 40” software. The following were used:
“mini-diabolos” test specimens, 2-3 specimens per condition;
a minimum force of 0 N, and a maximum force defined by the four conditions: 250 N, 200 N, 125 N or 100 N; and
a frequency of 5 Hz and a temperature of 23° C.

### Tests on Control Compositions C1-C3 and Crosslinked Composition I of the Invention:

The abovementioned morphology of the thermoplastic phase dispersed in crosslinked composition I according to the invention (as illustrated in FIGS. 7-8 and 9-11) allows, via the abovementioned mixing process, an overall improved reinforcement to be afforded for composition I in comparison to compositions C1-C3, as shown by the mechanical properties of composition I relative to the three control compositions C1-C3.

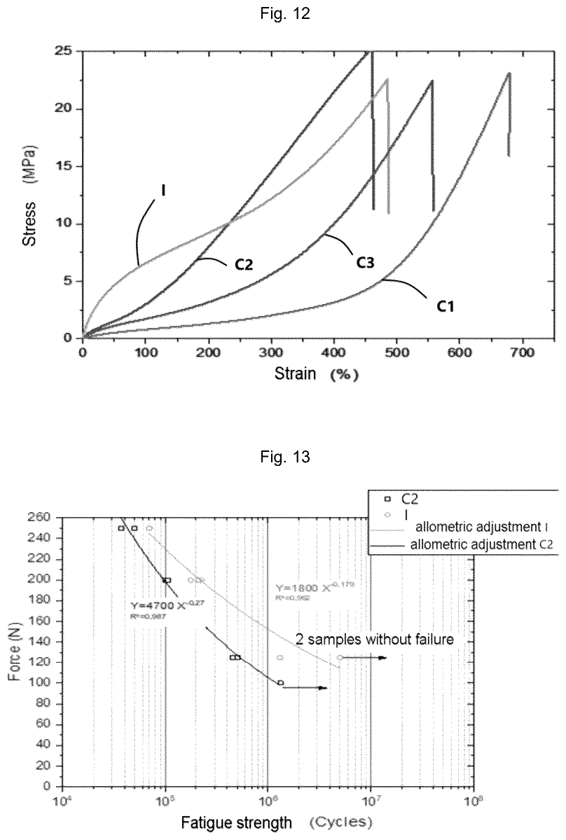

In particular, hardness and tensile tests (the stress-strain curves of which for compositions C1-C3 and I are collated in FIG. 12 and the results of which are detailed in Table 5 below), establish this improved reinforcement for composition I, notably relative to composition C3, which was nevertheless characterized by the same mass (and volume) fraction of PP.

The tensile curves in FIG. 12 show the reinforcement obtained for composition I, which was clearly superior to that of non-reinforced composition C1 and to that of composition C3 reinforced with PP nodules, and which was also comparable to that of composition C2 reinforced solely with carbon black.

TABLE 5

| Static properties of crosslinked | | | | | |
|---|---|---|---|---|---|
| compositions in the initial state | | | | | |
| (155° C. for t 95 min.) | | C1 | C2 | C3 | I |
| Shore A hardness at 3 s (±2 points) | (Points) | 38 | 62 | 49 | 67 |
| Secant modulus M100 | (MPa) | 0.8 | 3.1 | 1.7 | 6.8 |
| at 100% strain | | | | | |
| Secant modulus M200 | (MPa) | 1.3 | 8.2 | 3.2 | 9.5 |
| at 200% strain | | | | | |
| Secant modulus M300 | (MPa) | 2.0 | 14.7 | 5.6 | 12.5 |
| at 300% strain | | | | | |
| Breaking stress | (MPa) | 22.2 | 25.3 | 22.1 | 22.4 |
| Elongation at break | (%) | 670 | 461 | 555 | 480 |

In particular, this Table 5 shows that:
the Shore A hardness of composition I of the invention was not only 37% higher than that of composition C3 reinforced with PP nodules, but was also 8% higher than that of composition C2 reinforced with carbon black,
the moduli M100, M200 and M300 of composition I of the invention were very much higher than those of composition C3 (by 300%, 197% and 123%, respectively) and were higher than (cf. M100 and M200) or comparable to (cf. M300) those of composition C2, and that
the breaking properties of composition I of the invention were satisfactory, being generally of the same order as those of compositions C2 and C3.

Table 6 below details the dynamic properties obtained for compositions C1-C3 and I, by the abovementioned “DMA” dynamic mechanical analysis.

TABLE 6

| | | | |
|---|---|---|---|
| Compositions | C2 | C3 | I |

| | | | | |
|---|---|---|---|---|
| Static modulus | (MPa) | 6.034 | 3.790 | 5.327 |

Dynamic properties (“Goodrich” plot, measured
at t95 + 8 min. at 155° C.)

| | | | | |
|---|---|---|---|---|
| Modulus at 15 Hz | (MPa) | 8.04 | 4.04 | 7.14 |
| Tan D at 15 Hz | — | 0.107 | 0.056 | 0.098 |
| Modulus at 155 Hz | (MPa) | 11.20 | 4.66 | 9.27 |
| M155 Hz/M15 Hz | (MPa) | 1.393 | 1.153 | 1.298 |

These dynamic properties show a significant increase in the dynamic moduli at 15 Hz, at 155 Hz and in the M155/M15 Hz ratio of composition I according to the invention compared to composition C3 reinforced with PP nodules (increase of 77% for M15 Hz and 99% for M155 Hz), which is advantageously reflected in a reduction in mechanical non-linearities in frequency sweep, for composition I of the invention relative to composition C3.

The fatigue strength tests performed as explained above, the results of which are illustrated in FIG. 13 (with the number of cycles without breaking on the x axis and the forces in N on the y axis) for crosslinked compositions C2 and I, show excellent fatigue strength of the specimens consisting of composition I of the invention compared with those consisting of composition C2 reinforced with carbon black. Specifically, composition I showed a fatigue strength increased by a factor of about 2.5 for high stresses (cf. forces of 250 N or 200 N, for example), relative to composition C2. For lower forces, composition I of the invention had a fatigue strength of greater than 5 million cycles without breaking (test stopped at 5 million cycles), whereas composition C2 broke at about 500 000 cycles only.

1. A crosslinkable rubber composition based on at least one elastomer, composition comprising other ingredients which include a crosslinking system and a thermoplastic polymer phase which has at least a melting point Tf or softening point Tr, a glass transition temperature Tg and, when said phase is partly crystalline, a crystallization temperature Tc,
said phase being dispersed in said at least one elastomer in a form of particles, the crosslinking system comprising sulfur when said at least one elastomer is unsaturated and said phase comprises saturated polymer chains, and comprising a peroxide when said at least one elastomer is saturated,
the crosslinkable rubber composition comprising the product:
a) of a melt reaction by thermomechanical working of a reaction mixture comprising said at least one elastomer and said other ingredients with the exception of the crosslinking system to obtain a precursor mixture of the crosslinkable composition, the reaction comprising heating the reaction mixture up to a maximum temperature Ta of said reaction mixture which is higher than said at least one melting point Tf or softening point Tr, and then
b) mechanical working of the precursor mixture, with addition of the crosslinking system, to produce the crosslinkable composition,
in which said particles comprise filaments or fibrils, the temperature Tb of the precursor mixture during the mechanical working in step b) being temporarily greater than:
said crystallization temperature Tc when said phase is partly crystalline, or
said glass transition temperature Tg when said phase is amorphous.

2. The crosslinkable rubber composition as claimed in claim 1, in which the mechanical working of step b) is initiated at an initial temperature Tb0 of the precursor mixture, with Tb0>Tc or Tb0>Tg when said phase is partly crystalline or amorphous, respectively.

3. The crosslinkable rubber composition as claimed in claim 2, in which said temperature Tb of the precursor mixture during step b) is maximum when mechanical working is initiated, where Tb=Tb0, and then decreases until Tb<Tc or Tb<Tg, when said phase is partly crystalline or amorphous, respectively.

4. The crosslinkable rubber composition as claimed in claim 2, in which step a) is followed by step b) in such a way that a time interval Δt separates the extraction of the precursor mixture at the end of step a) and the initiation of mechanical working in step b) after transferring the precursor mixture, providing a temperature difference ΔT=Tt−Tb0 between a dropping temperature Tt of the precursor mixture at the end of step a) and the initial temperature Tb0 at the start of step b), such that ΔT/Tt<30%.

5. The crosslinkable rubber composition as claimed in claim 4, in which Δt<10 minutes, for ΔT/Tt to be less than 10%, the precursor mixture then being cooled on conclusion of step a) essentially by means of the mechanical working in step b), in such a manner that the precursor mixture is subjected to generally continuous shearing from the initiation of step a) until the end of step b).

6. The crosslinkable rubber composition as claimed in claim 2, in which mechanical working is initiated at said initial temperature Tb0 which is between
Tc or Tg, depending on whether said phase is partly crystalline or amorphous, respectively, and
said maximum temperature Ta of the reaction mixture, which coincides with a dropping temperature Tt of the precursor mixture.

7. The crosslinkable rubber composition as claimed in claim 6, in which Tb0 is between 15° and 190° C., said phase being:
partly crystalline, or
amorphous,
and in which said temperature Tb of the precursor mixture is maximum upon initiation of mechanical working, where Tb=Tb0, and then decreases until Tb is between 1° and 90° C.

8. The crosslinkable rubber composition as claimed in claim 1, in which said particles have at least one of the following morphological features:
(a) for their equivalent diameter, defined as the diameter of a hypothetical spherical particle of the same volume:
(i) an equivalent diameter ranging from 5 nm to 1000 nm for all of said particles,
(ii) a median equivalent diameter of between 20 nm and 200 nm, and
(iii) a mean equivalent diameter of between 30 nm and 300 nm; and/or
(b) for their aspect ratio, defined by the ratio of the longest length to the smallest width of each of said particles:
(i) a mean aspect ratio of greater than or equal to 2, and
(ii) a maximum aspect ratio for all of said particles which is greater than 5;
and in which the particles comprise filaments or fibrils in a volumetric fraction of greater than 70%.

9. A crosslinked rubber composition, in which the crosslinked rubber composition is the product of thermal crosslinking of a crosslinkable rubber composition as claimed in claim 1 by chemical reaction with said crosslinking system,
and in which the crosslinked rubber composition has at least one of the following properties:
(a) a Shore A hardness measured according to the standard ASTM D 2240 which is greater than or equal to 60;
(b) secant moduli M100, M200 and M300 at 100%, 200% and 300% strain, measured in uniaxial tension according to the standard ASTM D 412, which are respectively greater than 3 MPa, 6 MPa and 9 MPa;
(c) a modulus ratio M 155 Hz/M 15 Hz and a loss factor tan D at 15 Hz which are measured at 23° C. via a frequency sweep according to the standard ISO 4664 with a Metravib® visco-analyzer on Metravib® block-type specimens and which satisfy at least one of the following conditions (i) and (ii):
(i) M 155 Hz/M 15 Hz≤1.50,
(ii) a dynamic modulus at 15 Hz≥7 MPa, and
(iii) tan D at 15 Hz≤0.10; and
(d) a fatigue strength of greater than 5×10⁶ cycles, measured at a frequency of 5 Hz and a temperature of 23° C. with a hydraulic endurance machine “MTS 831.02 Elastomer Test System” with a maximum capacity of 25 KN, equipped with a 15 kN force cell and a ±60 mm stroke cylinder, run with the “MTS Flextest 40” software on “mini-diabolos” specimens with a minimum force of 0 N and a maximum force of 250 N, 200 N, 125 N and 100 N.

10. A mechanical member with a dynamic function chosen from antivibration supports and elastic articulations for motor vehicles or industrial devices, said member comprising at least one elastic part consisting of a crosslinked rubber composition which is suitable to be subjected to dynamic stresses, in which said crosslinked rubber composition is as claimed in claim 9.

11. A sealing element chosen from vehicle bodywork seals and building sealing profiles, said sealing element comprising an elastic part which consists of a crosslinked rubber composition, in which the crosslinked rubber composition is as defined in claim 9.

12. A process for preparing a crosslinkable rubber composition as claimed in claim 1, in which the process comprises the following steps:
a) in an internal mixer or in a screw extruder:
a0) introduction of said at least one elastomer and then of said other ingredients with the exception of said crosslinking system;
a1) thermomechanical working in the internal mixer or in the screw extruder, comprising melt mixing of said reaction mixture, with the exception of the crosslinking system, to produce a precursor mixture for the crosslinkable rubber composition;
a2) heating the reaction mixture up to said maximum temperature Ta of the reaction mixture, which is higher than said at least one melting point Tf or softening point Tr of the thermoplastic polymer phase, by a difference Ta−Tf or Ta−Tr of between 1 and 100° C.;
a3) stabilizing said heating for a holding time period of at least 10 seconds;
a4) extraction of the precursor mixture from the internal mixer or screw extruder; and then
b) mechanical working of the precursor mixture in an external roll mixer or in a conical twin-screw device, with addition of said crosslinking system comprising sulfur and/or a peroxide to produce the crosslinkable rubber composition, in such a manner that the temperature Tb of the precursor mixture is temporarily greater than:
said crystallization temperature Tc when the thermoplastic polymer phase is partly crystalline, and
said glass transition temperature Tg when the thermoplastic polymer phase is amorphous.

13. A process for preparing a crosslinkable rubber composition as claimed in claim 12, in which step b) is initiated at a maximum initial temperature Tb0 of the precursor mixture, with Tb0>Tc or Tb0>Tg when the thermoplastic polymer phase is partly crystalline or amorphous, respectively.

14. A process for preparing a crosslinkable rubber composition as claimed in claim 13, in which step a4) is followed by step b) in such a manner that a time interval Δt separates the extraction of the precursor mixture from the internal mixer or screw extruder and the initiation of the mechanical working in step b) after transfer of the precursor mixture into said external roll mixer or conical twin-screw device, providing a temperature difference ΔT=Tt−Tb0 between a dropping temperature Tt of the precursor mixture at the end of step a4) and the initial temperature Tb0 at the start of step b), such that ΔT/Tt<30%.

15. The process for preparing a crosslinkable rubber composition as claimed in claim 14, in which Δt<10 minutes, for ΔT/Tt to be less than 10%, such that the precursor mixture is cooled on conclusion of step a4) essentially by means of the mechanical working in step b), by being subjected to generally continuous shearing from step a1) until the end of step b).

16. The crosslinkable rubber composition as claimed in claim 2, in which the mechanical working of step b) is initiated while the thermoplastic polymer phase is in the molten or softened state in the precursor mixture.

17. The crosslinkable rubber composition as claimed in claim 4, in which the temperature difference ΔT=Tt−Tb0 is such that ΔT/Tt<20%.

18. The crosslinkable rubber composition as claimed in claim 5, in which Δt<2 minutes, for ΔT/Tt to be less than 1%.

19. The crosslinkable rubber composition as claimed in claim 6, in which said initial temperature Tb0 is between 11° and 220° C.

20. The crosslinkable rubber composition as claimed in claim 7, in which said phase is:
partly crystalline and comprises a propylene homopolymer or copolymer, or
amorphous and comprises a polystyrene,
and in which said crosslinking system is incorporated into the precursor mixture after a precursor mixture homogenization time period counted from the initiation of mechanical working, said homogenization time period being between 1 min. and 5 minutes.
